(19) United States
(12) Patent Application Publication
(10) Pub. No.: US 2010/0148412 A1
(43) Pub. Date: Jun. 17, 2010

(54) HYDRAULIC SHOCK ABSORBER

(75) Inventor: Yosuke MURAKAMI, Shizuoka (JP)

Correspondence Address: ORUM & ROTH LLC, 53 W. JACKSON BLVD., SUITE 1616, CHICAGO, IL, 60604, US

(73) Assignee: Showa Corporation, Saitama (JP)

(21) Appl. No.: 12/334,299

(22) Filed: Dec. 12, 2008

(51) Int. Cl. F16F 9/10

(52) U.S. Cl. 267/118

(57) ABSTRACT

In a hydraulic shock absorber, a second washer, which is assembled around a lower end projection of a lower spring receiver and is retained to enlarged portions provided at the tip end of the lower end projection so that the enlarged portions are prevented from falling, is attached to a step portion of an axle bracket, and the tip end of an inner tube, which is threadedly engaged with the axle bracket, is supported by the second washer.

### BACKGROUND OF THE INVENTION

1. Field of the Invention

The present invention relates to a vehicular hydraulic shock absorber.

2. Description of the Related Art

As described in Japanese Utility Model Application Laid-open No. 2-150439 (patent document 1), there is a vehicular hydraulic shock absorber in which an inner tube on the side; of an axle is slidably inserted into an outer tube on the side of a vehicle body. The inner tube is provided at its inner periphery with a partition wall member. A working oil chamber is defined below the partition wall member. An oil reservoir chamber is defined above the partition wall member. A piston rod mounted on the side of the outer tube is inserted into the working oil chamber such as to pass through the partition wall member. The piston rod is provided at its tip end with a piston which slides in the working oil chamber. A suspension spring is interposed between an upper spring receiver on the side of the piston rod and a lower spring receiver on the side of a bottom of the inner tube in the working oil chamber of the inner tube.

According to the hydraulic shock absorber of patent document 1, a plunger is slidably fitted into a bottom of the inner tube, the lower spring receiver for a suspension spring is placed on an upper portion of the plunger, the plunger is provided at its lower portion with a pressurizing chamber of working oil, the pressurizing chamber is pressurized by a pump piston which is operated from outside, thereby adjusting a spring load of the suspension spring from outside.

Japanese Utility Model Application Laid-open No. 60-139591 (patent document 2) discloses a hydraulic shock absorber in which a spring load of a suspension spring is supported by a plunger, a slant member which, is opposed to the plunger is provided, and an adjusting bolt presses a ball interposed between the plunger and a slant of the slant member so that the spring load of the suspension spring can be adjusted from outside.

According to the hydraulic-shock absorber of patent document 1, it is necessary to slidably assemble the plunger and the pump piston on the side of the bottom of the inner tube, so it becomes difficult to machine parts and to assemble and this increases the cost.

Further, the load of the suspension spring is supported by the working oil in the pressurizing chamber. It is difficult to seal the high pressure of the working oil in the pressurizing chamber, and the cost is increased.

According to the hydraulic shock absorber of patent document 2, a ball pushed by the adjusting bolt is pressed from the lateral direction with respect to the slant of the slant member, and the ball is pushed up above the slant. There is an adverse possibility that the slant is deformed by the point contact with the ball and the durability of the slant member is deteriorated. A diameter of the ball is limited by the installation space, and a large adjusting width of the spring load can not be secured.

In a hydraulic shock absorber, it is preferable that the spring load of the suspension spring can also be adjusted without detaching the axle from the hydraulic shock absorber.

### SUMMARY OF THE INVENTION

An object of the present invention is to simplify the structure that vertically moves a lower spring receiver from outside while an axle is not detached, and to secure a sufficient spring load adjusting width and durability in a hydraulic shock absorber that adjusts a spring load of a suspension spring by vertically moving a lower spring receiver provided on the side of a bottom of an inner tube.

The present invention relate to a hydraulic shock absorber in which an axle-side inner tube is slidably inserted into a vehicle body-side outer tube, the inner tube is provided at its inner periphery with a partition wall member, a working oil chamber is defined below the partition wall member, and an oil reservoir chamber is defined above the partition wall member. A piston support member mounted on the side of the outer tube is inserted into the working oil chamber so as to penetrate the partition wall member. The piston support member is provided at its tip end with a piston which slides in the working oil chamber. A suspension spring is interposed between an upper spring receiver on the side of the piston support member and a lower spring receiver on the side of a bottom of the inner tube in the working oil chamber of the inner tube. An adjusting bolt facing outside is provided on a bottom of the inner tube at a location separate from an axle mounting hole of the bottom of the inner tube. A slider provided on the bottom of the inner tube can move straight in a direction intersecting with a center axis of the inner tube by rotation force of the adjusting bolt. A lower slant of the lower spring receiver is placed on an upper slant of the slider, and the lower spring receiver is vertically moved by rotation of the adjusting bolt, thereby adjusting the spring load of the suspension spring.

The present invention relate to a hydraulic shock absorber in which an axle-side inner tube is slidably inserted into a vehicle body-side outer tube, and an axle bracket is threadedly engaged with a lower end of the inner tube. The inner tube is provided at its inner periphery with a partition wall member, a working oil chamber is defined below the partition wall member, and an oil reservoir chamber is defined above the partition wall member. A piston support member mounted on the side of the outer tube is inserted into the working oil chamber so as to penetrate the partition wall member. The piston support member is provided at its tip end with a piston which Slides in the working oil chamber, and a suspension spring is interposed between an upper spring receiver on the side of the piston support member and a lower spring receiver on the side of the axle bracket in the working oil chamber of the inner tube. The lower spring receiver is inserted into the axle bracket so as to be prevented from being rotated with respect to the axle bracket. The hydraulic shock absorber includes a spring ad adjusting apparatus that include an adjusting bolt facing outside provided on the axle bracket at a location separate from an axle mounting hole of the axle bracket, and vertically moves the lower spring receiver by rotation of the adjusting bolt, thereby actuating the spring load of the suspension spring. A second washer, which is assembled around the lower end projection of the lower spring receiver and is retained to expanded potions provided at the tip end of the lower end projection so that the expanded portions are prevented firm failing, is attached to a step portion of the axle bracket, and the tip end of the inner tube, which is threadedly engaged with the axle bracket, is supported by the second washer.

### BRIEF DESCRIPTION OF THE DRAWINGS

The present invention will be more fully understood from the detailed description given below and from the accompanying drawings which should not be taken to be a limitation on the invention, but are for explanation and understanding only.

The drawings:

FIG. 1 is a sectional view showing an entire hydraulic shock absorber;

FIG. 2 is a sectional view showing a spring load adjusting apparatus;

FIG. 3 is a sectional view showing a damper force adjusting apparatus;

FIG. 4 is an enlarged view of an essential portion of FIG. 2;

FIGS. 5A and 5B show nuts, wherein FIG. 5A is a front view and FIG. 5B is a sectional view;

FIG. 6A to 6C show sliders, wherein FIG. 6A is a front view, FIG. 6B is a side view and FIG. 6C is a sectional view taken along the line C-C in FIG. 6A;

FIG. 7A to 7C show lower spring receivers, wherein FIG. 7A is a front view, FIG. 7B is a sectional view and FIG. 7C is a plan view;

FIGS. 8A and 8B show lower end of the lower spring receivers, wherein FIG. 8A is a bottom view and FIG. 8B is a sectional view taken along the line B-B in FIG. 8A; and

FIGS. 9A and 9B show a modification of the slider, wherein FIG. 9A is a front view and FIG. 9B is a side view.

### DESCRIPTION OF THE PREFERRED EMBODIMENTS

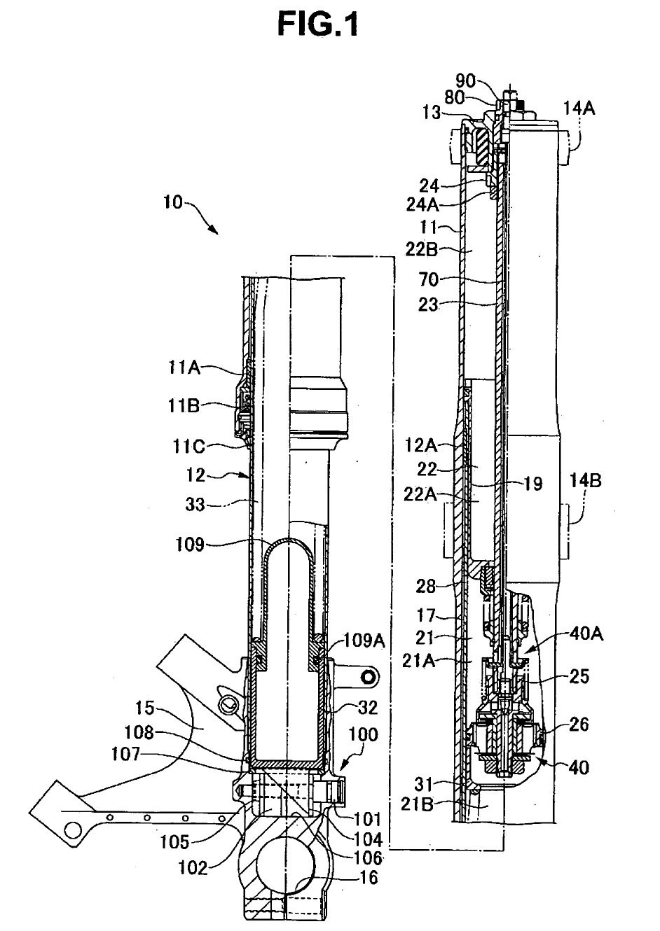

A front fork (a hydraulic shock absorber) 10 in one embodiment is an inverted front fork in which an outer tube 11 is disposed on the side of the vehicle body, and an inner tube 12 is disposed on the side of a wheel. As shown in FIGS. 1 to 3, the inner tube 12 is slidably inserted into the outer tube 11 through a guide bush 11A fixed to an inner periphery of an opening of a lower end of the outer tube 11 and a guide bush 12A fixed to an outer periphery of an opening of an upper end of the inner tube 12. A reference symbol 11B represents an oil seal, and a reference symbol 11C represents a dust seal. A cap 13 is liquid-tight and threadedly engaged with the opening of the upper end of the outer tube 11, and the outer tube 11 is provided at its outer periphery with vehicle body-side mounting members 14A and 14B. An axle bracket 15 is liquid-tight and threadedly engaged with the opening of the lower end of the inner tube 12 to form a bottom of the inner tube 12, and the axle bracket 15 is formed with an axle mounting hole 16.

The front fork 10 defines an annular oil chamber 17 defined by the inner periphery of the outer tube 11, the outer periphery of the inner tube 12 and the two guide bushes 11A and 12A.

The front fork 10 is provided with a partition, wall member 19 liquid tight by virtue of an O-ring around an inner periphery of an upper end side of the inner tube 12. A working oil chamber 21 is defined in the partition wall member 19 at a location lower than the rod guide portion 19A, and an oil reservoir chamber 22 is defined in the partition wall member 19 at a location higher than the rod guide portion 19A. In the oil reservoir chamber 22, its lower region is an oil chamber 22A, and an upper region is an air chamber 22B.

In the front fork 10, a piston rod 23 mounted on the outer tube 11 is slidably inserted into the rod guide portion 19A of the partition wall member 19. More specifically, a hollow piston rod 23 is threadedly engaged with a mounting collar 24 threadedly engaged with a lower end of a center portion of a cap 13, and is fixed by a lock nut 24A.

A piston 26 which comes into slide contact with an inner periphery of an inner tube 12 is fixed to a piston bolt 25 threadedly engaged with a tip end of the piston rod 23 inserted into the inner tube 12 from a rod guide portion 19A of the partition wall member 19. The oil chamber 21 is defined into a piston rod-side oil chamber 21A in which the piston rod 23 is accommodated and into a piston side oil chamber 21B in which the piston rod 23 is not accommodated. The piston 26 is fixed by a nut 27.

The front fork 10 brings the annular oil chamber 17 into communication with the piston rod-side oil chamber 21A through an oil hole 28 formed in the inner tube 12.

An upper spring receiver 31 of the front fork 10 is urged against the lower end surface facing the piston side oil chamber 21B of the piston 26. A lower spring receiver 32 is disposed on a bottom of the inner tube 12 formed by the axle bracket 15, and a suspension spring 33 is interposed between the upper spring receiver 31 and the lower spring receiver 32. The front fork 10 absorbs an impact force received from a road surface, when the vehicle runs, through expansion, compression and vibration of the suspension spring 33. At that time, the spring load adjusting apparatus 100 vertically moves the lower spring receiver 32, and the spring load of the suspension spring 33 can be adjusted.

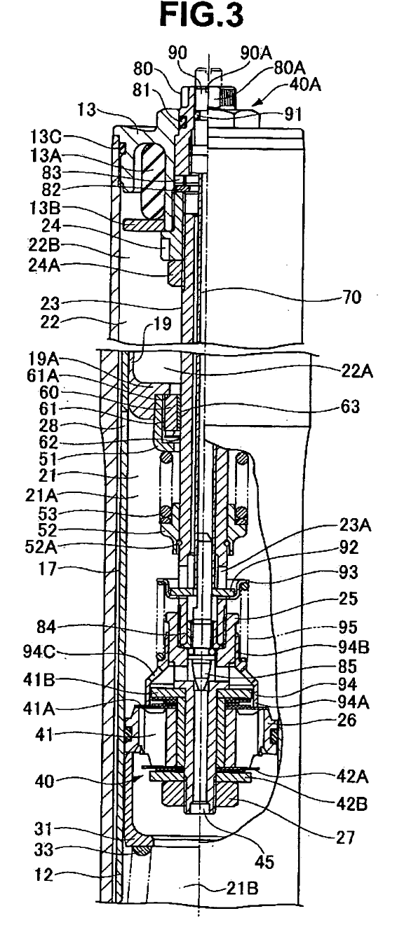

In the front fork 10, the piston 26 has a damping force generating apparatus 40 (FIG. 3).

The damping force generating apparatus 40 includes a compression side flow path 41 and an expansion side flow path 42 (not shown). The compression side flow path 41 is opened and closed by a compression side disk valve 41A (a compression side damping valve) which is backed up by a valve stopper 41B. The expansion side flow path 42 is opened and closed by an expansion side disk valve 42A (an expansion side damping valve) which is backed up by a valve stopper 42B. The valve stopper 41B, the valve 41A, the piston 26, the valve 42A, and the valve stopper 42B constitute a valve assembly inserted into the piston bolt 25. The valve assembly is sandwiched and fixed by the nut 27 which is threadedly engaged with the piston bolt 25.

The damping force generating apparatus 40 is provided at a center of the cap 13 with a later-described damping force adjusting apparatus 40A. A needle valve 85 of the damping force adjusting apparatus 40A is inserted into a hollow portion of the piston rod 23, and an opening space of the bypass passage 45 provided in the piston rod 23 is adjusted by vertical motion of a needle valve 85. The bypass passage 45 bypasses the piston 26, and brings the piston rod-side oil chamber 21A and the piston side oil chamber 21B into communication with each other.

In a compression side stroke, the damping force generating apparatus 40 generates a compression side damping force by a passage resistance of the bypass passage 45 whose opening space is adjusted by the needle valve 85 in the low speed region, and generates a compression side damping force by bending deformation of the compression side disk valve 41A in the intermediate/high speed region. In an expansion side stroke, the damping force generating apparatus 40 generates the expansion side damping force by the passage resistance of the bypass passage 45 whose opening space is adjusted by the needle valve 85 in the low speed region, and generates the expansion side damping force by bending deformation of the expansion side disk valve 42A in the intermediate/high speed region. The expansion, compression and vibration of the suspension spring 33 are controlled by the compression side damping force and the expansion side damping force.

In the front fork 10, a stopper rubber 13A and a stopper plate 13B on which an upper end of the partition wall member 19 provided on the inner tube 12 strikes in the most compressed stroke are fixed to a lower end surface of the cap 13, and the maximum compression stroke is limited by the stopper rubber 13.

The front fork 10 has a rebound spring 53 interposed between a spring sheet 51 which is swaged and fixed to a lower end surface of the partition wall member 19 on the side of an upper end of the inner tube 12 facing the piston rod-side oil chamber 21A, and a spring sheet 52 retained to a stopper ring 52A provided on the piston rod 23. When the front fork 10 is at maximum expansion, the partition wall member 19 pressurizes the rebound spring 53 between the spring sheet 52 and the partition wall member 19, thereby limiting the maximum expansion stroke.

Therefore, in the front fork 10, a cross-sectional area S1 of the annular oil chamber 17 comprising an annular gap between the outer tube 11 and the inner tube 12 is greater than a cross-sectional area (area surrounded by an outer diameter) S2 of the piston rod 28 (S1>S2 including S1≧S2).

The rod guide portion 19A of the partition wall member 19 is provided with a check valve 60 which permits oil to flow from the oil reservoir chamber 22 into the piston rod-side oil chamber 21A in the compression side stroke, and which prevents oil from flowing from the piston rod-side oil chamber 21A into the oil reservoir chamber 22 in the expansion side stroke. A valve chamber 61 is provided in an inner periphery of the rod guide portion 19A of the partition wall member 19, and the check valve 60 is accommodated between the step portion 61A on the upper end, of the valve chamber 61 and the backup spring 62 on the spring sheet 51 provided on the lower end of the valve chamber 61. The check valve 60 is shorter than a distance between the step portion 61A and the spring sheet 51, and a lateral groove is formed in the lower end surface of the check valve 60. The check valve 60 is provided with an inner periphery of the valve chamber (51 provided in the rod guide portion 19A of the partition wall member 19 and is vertically displaceable. The outer periphery of the check valve 60 forms a flow path between the outer periphery of the check valve 60 and the inner periphery of the valve chamber 61 provided in the rod guide portion 19A of the partition wall member 19. Oil flows through the flow path from the oil reservoir chamber 22 into the piston rod-side oil chamber 21A. A bush 63 which slidably supports the piston rod 23 is press-fitted into the check valve 60. In the compression side stroke, the check valve 60 moves downward together with the piston rod 23 which enters the inner tube 12, stops at the spring sheet 51, and forms a gap between the check valve 60 and the step portion 61A. Oil in the oil reservoir chamber 22 can be flowed into the piston rod-side oil chamber 21A through a gap with respect to the step portion 61A from the lateral groove through the outer periphery thereof. In the expansion side stroke, the check valve 60 moves upward together with the piston rod 23 which retreats from the inner tube 12, stops at the step portion 61A, closes the gap between the check valve 60 and the step portion 61A, and prevents oil in the piston rod-side oil chamber 21A from being discharged into the oil reservoir chamber 22 in the opposite path of the compression side stroke.

No oil seal is mounted on a periphery of the piston rod 23 of the rod guide portion 19A of the partition wall member 19. Thus, a fine flow path (orifice) 64 (not shown) which brings the piston rod-side oil chamber 21A and the oil reservoir chamber 22 into communication with each other is formed by a fine gap (fine gap formed by the check valve 60 between the step portion 61A) formed around the piston rod 23 by the bush 63 which is press-fitted, to the inner periphery of the check valve 60. The fine flow path 64 is formed in the rod guide portion 19A of the partition wall member 19, and in this way the piston rod-side oil chamber 21A and the oil reservoir chamber 22 may be in communication with each other.

The hydraulic shock absorber 10 is operated in the following manner.

### (Compression Side Stroke)

An entering capacity amount of working oil of the piston rod 23 which enters the inner tube 12 in the compression side stroke is sent to the annular oil chamber 17 from the oil chamber 21A of the inner periphery of the inner tube 12 through the oil hole 28 of the inner tube 12. At that time, since the increased capacity amount ΔS1 (supply amount) of the annular oil chamber 17 is greater than the increased capacity amount ΔS2 of the piston rod 23, a shortage amount (ΔS1-ΔS2) of a necessary supply amount of oil into the annular oil chamber 17 is supplied from the oil reservoir chamber 22 through the check valve 60.

In the compression side stroke, as described above, the compression side damping force is generated by the passage resistance of the bypass passage 45 whose opening space is adjusted by the needle valve 85 in the low speed region, and the compression side damping force is generated by the bending deformation of the compression side disk valve 41A in the intermediate/high speed region.

### (Expansion Side Stroke)

In the expansion side stroke, a retreating capacity amount of working oil of the piston rod 23 which is retreated from the inner tube 12 is sent to the oil chamber 21A of the inner periphery of the inner tube 12 through the oil hole 28 of the inner tube 12 from the annular oil chamber 17. At that time, since the reduced capacity amount ΔS1 (discharge amount) of the annular oil chamber 17 is greater than the reduced capacity amount ΔS2 of the piston rod 23, a surplus amount (ΔS1-ΔS2) of oil from the annular oil chamber 17 is discharged into the oil reservoir chamber 22 through the fine flow path 64.

In the expansion side stroke, as described above, the expansion side damping force is generated by the passage resistance of the bypass passage 45 whose opening degree is adjusted by the needle valve 85 in the low speed region, and the expansion side damping force is generated by the bending deformation of the expansion side disk valve 42A in the intermediate/high speed region. The expansion side damping force is also generated by the passage resistance of the fine flow path 64.

The damping force adjusting apparatus 40A will be explained below.

As shown in FIG. 3, the damping force adjusting apparatus 40A includes a single push rod 70 which has a noncircular cross section, in this embodiment, D-shaped cross section and which can move in the rotation direction and axial direction in the hollow portion of the piston rod 23. Also included is a first adjusting portion 80 which moves the push rod 70 in the rotation direction and a second adjusting portion 90 which moves the push rod 70 in the axial direction. These elements are coaxially disposed on an upper portion of the front fork 10 and on an extension of the push rod 70. In the damping force adjusting apparatus 40A, a needle valve 85 which slidably engages in the noncircular cross section of the push rod 70 is threadedly engaged with the hollow portion of the piston rod 23. The needle valve 85 is threadedly moved by rotation of the first adjusting portion 80, an opening space of the bypass passage 45 is adjusted by the needle valve 85, and the damping force can be adjusted by the passage resistance of the bypass passage 45. The damping force adjusting apparatus 40A biases the compression side disk valve 41A in its closing direction by a spring 95 which urges the push rod 70 in the axial direction, and the compression side damping force can be adjusted by bending deformation of the compression side disk valve 41A. Structures of the first adjusting portion 80 and the second adjusting portion 90, a damping force adjusting structure using the needle valve 85 and a damping force adjusting structure using the spring 95, will be explained.

### (Structures of First Adjusting Portion 80 and Second Adjusting Portion 90) (FIG. 3)

The cap 13 constituting a cap assembly is threadedly engaged in a liquid tight manner with an opening of an upper end of the outer tube 11 through the O-ring 13C. The mounting collar 24 is threadedly engaged with the lower end opening of the cap 13, and an upper end of the piston rod 23 is threadedly engaged with the mounting collar 24 and is fixed by the lock nut 24A.

The first adjusting portion 80 is inserted in a liquid tight manner from the lower end opening of the center hole of the cap 13 through an O-ring 81. The first adjusting portion 80 is engaged with the intermediate step portion of the cap 13 in the axial direction so that the first adjusting portion 80 is prevented from being pulled out upward. The first adjusting portion 80 urges the flat washer 82 in the axial direction which is placed on an upper end surface of the mounting collar 24 which is threadedly engaged with the lower end opening of the cap 13, so that the first adjusting portion 80 is prevented from being pulled out downward. As a result, the first adjusting portion 80 is rotatably provided on the cap 13 using an operating surface 80A on an upper end outer periphery. The lower end surface of the first adjusting portion 80 which urges the flat washer 82 includes a lateral groove. Both side projections of the engaging piece 83 are engaged with the lateral groove almost without play in the rotation direction. An outer periphery of noncircular cross section (D-shaped cross section) of the push rod 70 passes through a noncircular hole (D-shaped hole) formed in the center of the engaging piece 83. The outer periphery is engaged almost without play in the rotation direction, and the outer periphery can slide in the axial direction. With this, the first adjusting portion 80 can move the push rod 70 in the rotation direction.

The second adjusting portion 90 is inserted in a liquid tight manner into the lower end opening of the center hole of the first adjusting portion 80 through an O-ring 91. The second adjusting portion 90 is engaged with an intermediate step portion of the first adjusting portion 80 in the axial direction so that the second adjusting portion 90 is prevented from being pulled out upward. A lower end surface of the second adjusting portion 90 contacts, without gap in the axial direction, an upper end surface of the push rod 70 which penetrates a noncircular hole of the engaging piece 83 which is engaged with a side of the first adjusting portion 80. The push rod 70 is biased upward by a spring force of a later described spring 95, and an upper end surface of the push rod 70 always contacts the lower end surface of the second adjusting portion 90. The second adjusting portion 90 is threadedly moved with respect to the first adjusting portion 80 using the operating groove 90A of the upper end surface, and the push rod 70 can be moved in the axial direction.

(Damping Force Adjusting Structure using Needle Valve 85) (FIG. 3)

An inner base 84 is inserted into a lower end of a hollow portion of the piston rod 23, and a lower end surface of the piston rod 23 and an inner diameter step portion of the piston bolt 25 contain and fix a lower end flange of the inner base 84. The inner base 84 may be press-fitted into the hollow portion of the piston rod 23. The needle valve 85 is inserted in a liquid tight manner into the inner periphery of the inner base 84 fixed to the piston rod 23, and a screw portion of an intermediate portion of the needle valve 85 is threadedly engaged with an inner periphery of the piston bolt 25. A noncircular cross section of an upper end of the needle valve 85, in this embodiment, a noncircular cross section forming a D-shaped cross section, is inserted into a noncircular cross section of a lower end of the push rod 70 almost without play such that the former noncircular cross section can slide in the axial direction and can engage in the, rotation direction.

If the first adjusting portion 80 moves the push rod 70 in the rotation direction as described above, the needle valve 85 which is engaged with the plush rod 70 in the rotation direction threadedly moves with respect to the piston bolt 25. The needle valve 85 moves forward and rearward with respect to a valve sheet of a vertical hole upper end of the bypass passage 45 provided in the piston bolt 25. The opening space of the bypass passage 45 is adjusted, and the compression side damping force and the expansion side damping force can be adjusted by passage resistance of the bypass passage 45.

When the first adjusting portion 80 threadedly moves the needle valve 85 through the push rod 70, the needle valve 85 idles with respect to a center hold of a pushing piece 92 for a later-described spring 95, and the spring 95 is not influenced.

(Damping Force Adjusting Structure using Spring 95) (FIG. 3)

Long guide holes 23A extending in the axial direction are provided on both sides of the lower end of the piston rod 23 in the radial direction, and both side projections of the pushing piece 92 are slidably inserted into the guide holes 23A almost without play. A lower end surface of the push rod 70 which is inserted into the hollow portion of the piston rod 23 contacts directly an upper surface of the pushing piece 92, and a noncircular cross section of the needle valve 85 which is inserted into the lower end of the push rod 70 is loosely inserted into a circular hole formed in a center of the pushing piece 92 such that the noncircular cross section can move in the axial direction.

Spring receivers 93 which contact both end projections of the pushing piece 92 from below and a valve holding member 94 which contacts an upper surface (back surface) of the compression side disk valve 41A are disposed around a lower end (piston bolt 25) of the piston rod 23, and a valve holding member spring 95 is interposed between the spring receiver 93 and the valve holding member 94. The spring receiver 93 is of a cup-like shape. The spring receiver 93 contacts both side projections of the pushing piece 92 at an inner peripheral lower end of the cup, and the spring receiver 93 allows the spring 95 to sit on an upper end outer peripheral flange of the cup. The valve holding member 94 includes an annular holding member 94A which continuously (or intermittently) contacts the entire circumference of the compression side disk valve 41A at a position of appropriate outer diameter of the upper surface, a slide portion 94B which is slid and guided by an upper end outer periphery of the piston bolt 25, and an oil passage 94C which brings the piston rod-side oil chamber 21A into communication with the compression side flow path 41, the expansion side flow path 42 and the bypass passage 45. The valve holding member 94 allows the spring 95 to sit on the outer peripheral step portion.

If the second adjusting portion 90 moves the push rod 70 in the axial direction as described above, the pushing piece 92 against which the lower end surface of the push rod 70 is in contact vertically moves the spring receiver 93 to expand and shrink the valve holding member spring 95, and a set load of the spring 95 is adjusted. With this, the set load of the spring 95 biases the compression side disk valve 41A in its closing direction through the valve holding member 94 so that the compression side damping force by bending deformation of the compression side disk valve 41A can be adjusted. The valve holding member 94 can be replaced by one having different diameter of the holding member 94A. A valve holding member 94 having a holding member 94A of large diameter hold, an outer peripheral side of the compression side disk valve 41A, wherein damping force is increased from a low speed region of piston speed. A valve holding member 94 having a holding member 94A of small diameter holds an inner peripheral side of the compression side disk valve 41A, and increases the damping force in intermediate and high speed regions of piston speed.

When the second adjusting portion 90 moves the pushing piece 92 through the push rod 70, the push rod 70 and the pushing piece 92 idle in the axial direction with respect to the needle valve 85, and the needle valve 85 is not influenced.

The front fork 10 has the damping force adjusting apparatus 40A and exhibits the following effects.

(a) It is possible to arrange the front fork 10 such that the first adjusting portion 80 and the second adjusting portion 90 are disposed on the upper portion of the front fork 10 and are coaxially disposed on the extension of the push rod 70. The first adjusting portion 80 and the push rod 70 are easily connected to each other in the rotation direction, and the second adjusting portion 90 and the push rod 70 are easily connected to each other in the axial direction. The structure is simple, the number of parts is reduced, and operation failure is less prone to be generated.

(b) Since the first adjusting portion 80 and the second adjusting portion 90) are coaxially disposed on the upper portion of the front fork 10, this can be applied to the front fork 10 which can be adjusted only from the upper end surface of the outer tube 11. Since the first adjusting portion 80 and the second adjusting portion 90 do not have directional properties in the circumferential direction of the outer tube 11, assembling positions into the vehicle body-side mounting members 14A and 14B in the circumferential direction are arbitrary, and the assembling performance is excellent.

(c) One hollow push rod 70 having a noncircular cross section is used, and the needle valve 85 is slidably inserted into the noncircular cross section of the push rod 70. Since the needle valve 85 is accommodated in the inner diameter of the push rod 70, an accommodation space of the needle valve 85 is not required around the outer periphery of the push rod 70, and the push rod 70 can advantageously be applied to the front fork 10 having the thin piston rod 23.

(d) The first adjusting portion 80 is rotatably provided on the cap 13 of the upper portion of the front fork 10, the engaging piece 83 is engaged in the groove formed in the end surface of the first adjusting portion 80 in the rotation direction, and the outer periphery of the noncircular cross section of tho push rod 70 can engage with the noncircular hole formed in the engaging piece 83 in the rotation direction, and can slide in the axial direction. The second adjusting portion 90 is threadedly engaged with the center hole of the first adjusting portion 80, and the end surface of the second adjusting portion 90 can contact the end surface of the push rod 70 penetrating the noncircular hole of the engaging piece 83 in the axial direction. Therefore, the first adjusting portion 80 and the second adjusting portion 90 can be compactly disposed coaxially on the upper portion of the front fork 10, the rotation force of the first adjusting portion 80 can easily be transmitted to the push rod 70, and the axial force of the second adjusting portion 90 can be transmitted to the push rod 70 directly.

The spring load adjusting apparatus 100 which vertically moves the lower spring receiver 32 and adjusts the spring load of the suspension spring 33 will be explained below.

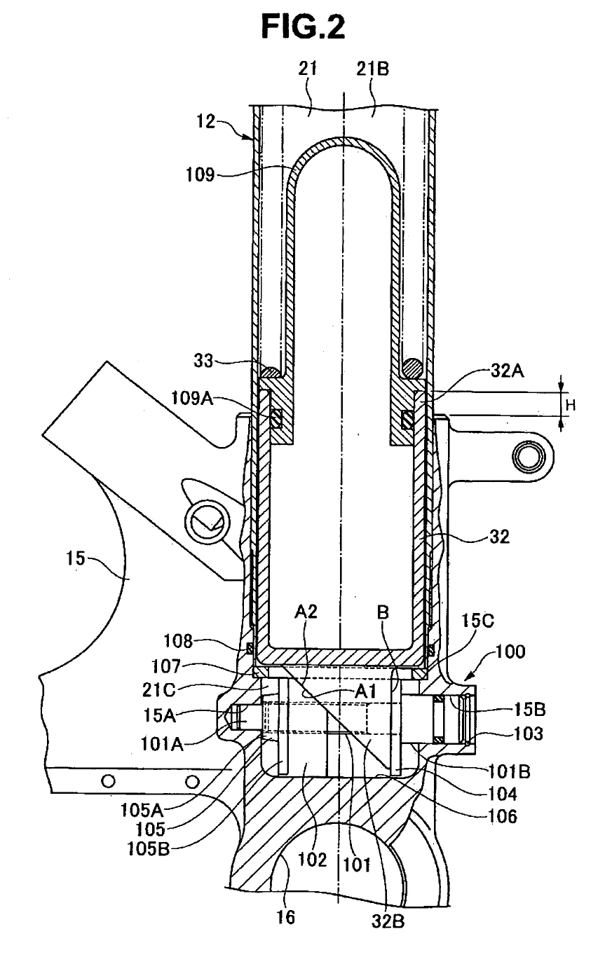

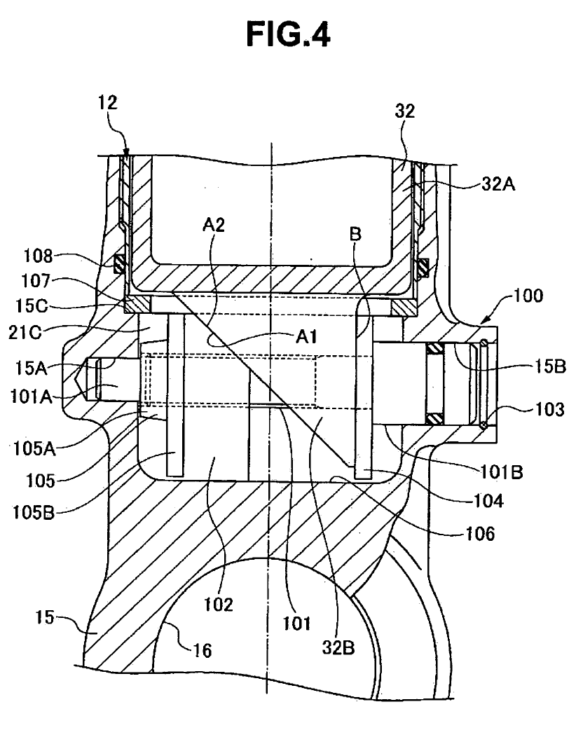

As shown in FIGS. 2 and 4, in the spring load adjusting apparatus 100, an adjusting bolt 101 facing outside at a position (near the axle mounting hole 16) separate from the axle mounting hole 16 of the axle bracket 15 constituting a bottom of the inner tube 12 is provided on the bottom. A slider 102 provided on a bottom inside of the axle bracket 15 (surface facing the lower end of the lower spring receiver 32) can move straight in a direction intersecting the center axis of the inner tube 12 (axial direction of the adjusting bolt 101) by the rotation force of the adjusting bolt 101. A lower slant A1 of the lower spring receiver 32 is placed on an upper slant A2 of the slider 102, the lower spring receiver 32 is vertically moved by the rotation of the adjusting bolt 101, and the spring load of the suspension spring 33 is adjusted. This will be explained below in more detail.

(1) A tip end shaft portion 101A and a base end boss portion 101B of the adjusting bolt 101 are rotatably inserted into mounting holes 15A and 15B which intersect perpendicularly (or diagonally intersect) to a center axis (the same as the center axis passing through the axle mounting hole 16 of the inner tube 12 when the axle bracket 15 is mounted on the inner tube 12) passing through the axle mounting hole 16 of the axle bracket 15 before it is threadedly engaged with the lower end opening of the inner tube 12. The mounting hole 15A is a closed hole, the mounting hole 15B is a through hole, a retaining ring 103 is retained to the opening of the mounting hole 15B to which the base end boss portion 101B is rotatably attached together with an O-ring, and the adjusting bolt 101 is prevented from being pulled out.

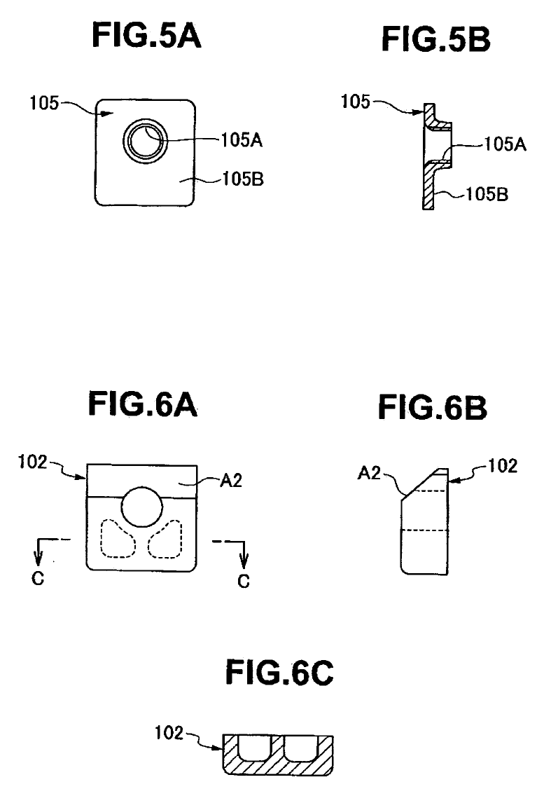

(2) When the adjusting bolt 101 is rotatably attached to the axle bracket 15 as described in (1), a washer 104 (first washer), a slider 102 and a nut 105 are attached to the intermediate portion of the adjusting bolt 101. That is, the washer 104 is abutted against the step surface formed by the base end boss portion 101B on the side of the base end of the adjusting bolt 101. The washer 104 is of tetragonal shape, and its lower side is abutted against the slide surface 106 of the bottom inside of the axle bracket 15 to prevent the rotation. The slider 102 is attached to the tip end of the adjusting bolt 101, and the nut 105 added and attached to the slider 102 is threadedly engaged with its screw portion. As shown in FIGS. 5A and 5B, the nut 105 includes a nut portion 105A, and has a quadrate plate 105B which is continuous with the nut portion 105A. A lower side of the plate 105B is abutted against the slide surface 106 of the axle bracket 15 to prevent rotation. As shown in FIGS. 6A and 6B, the slider 102 having quadrangle shape, has a hole into which the adjusting bolt 101 is inserted. A lower side of the slider 102 is abutted against the slide surface 106 of the axle bracket 15 to prevent the rotation, and its upper side is an upper slant A2.

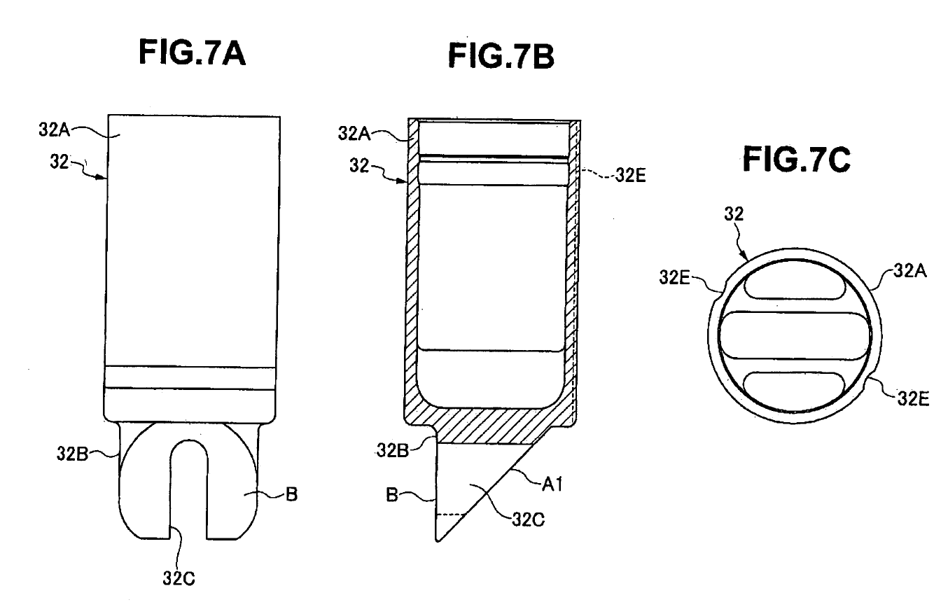

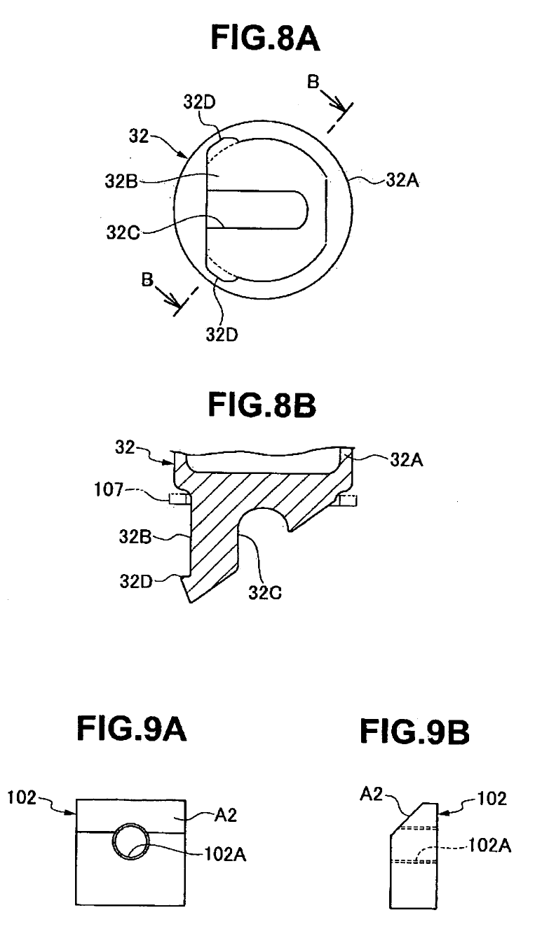

(3) The lower spring receiver 32 is inserted into the axle bracket 15. As shown in FIGS. 7A to 7C, in the lower spring receiver 32, a lower end projection 32B projects from a bottom of a bottomed cylindrical portion 32A, one end surface of the lower end projection 32B is the lower slant A1 and the other end surface thereof is a lower vertical surface B as viewed from side. The lower slant A1 and the lower vertical surface B intersect with each other at an acute angle. The lower spring receiver 32 includes a U-shaped rotation preventing groove 32C which extends on the central portion of the lower end projection 32B as viewed from front from the lower slant A1 to the lower vertical surface B, and which opens downward of the lower end projection 32B. As shown in FIG. 4, in the lower spring receiver 32 inserted into the axle bracket 15, the lower end projection 32B is sandwiched between the slider 102 and the washer 104, the lower slant A1 is placed on the upper slant A2 of the slider 102, and the lower vertical surface B is abutted against the end surface of the washer 104. At that time, the rotation preventing groove 32C of the lower spring receiver 32 sandwiches the intermediate portion of the adjusting bolt 101 so that the rotation preventing groove 32C is prevented from being rotated with respect to the center axis of the axle bracket 15.

When the lower spring receiver 32 is inserted into the axle bracket 15, a washer 107 (second washer) for supporting the tip end of the inner tube 12 is attached to a step portion 15C of the bottom inside of the axle bracket 15. The washer 107 is assembled around the lower end projection 32B of the lower spring receiver 32, and the washer 107 is retained to enlarged portions 32D provided on both sides of the tip end of the lower end projection 32B so that the enlarged portions 32D are prevented from falling.

(4) The axle bracket 15 is inserted into and threadedly engaged with the lower end of the inner tube 12 through an O-ring 108. The inner tube 12 is inserted into the annular gap between the inner periphery of the axle bracket 15 and a cylindrical portion 32A of the lower spring receiver 32 almost without a gap. At that time, the upper end surface of the cylindrical portion 32A of the lower spring receiver 32 projects from the upper end surface of the axle bracket 15 by H as shown in FIG. 2. The upper end of the cylindrical portion 32A is inserted into the inner periphery of the inner tube 12, and then, the lower end of the inner tube 12 is introduced into the annular gap between the cylindrical portion 32A and the inner periphery of the axle bracket 15. In this manner, the assembling performance of the inner tube 12 and the axle bracket 15 becomes excellent. At the time of the assembling operation, even if the axle bracket 15 is inverted vertically, the washer 107 stays and is not pulled out due to the existence of the O-ring 108 attached to the annular groove in the axle bracket 15.

(5) A cup-like spring collar 109 is fitted into the upper end opening of the cylindrical portion 32A of the lower spring receiver 32 in a liquid-tight manner through an O-ring 109A, and a flange of the spring collar 109 is placed on an upper end surface of the cylindrical portion 32A. The lower spring receiver 32 and the spring collar 109 maintain an internal space which is mutually integrally fused to each other in a cavity. An amount of oil to be charged into the oil chamber 21 of the inner tube 12 is reduced and the weight of the oil is reduced. Then, the suspension spring 33 is inserted into the inner tube 12, and the suspension spring 33 is supported by the lower spring receiver 32 through the flange of the spring collar 109.

If the adjusting bolt 101 is threadedly moved in a state in which the front fork 10 is assembled, the lower spring receiver 32 slides on the inner periphery of the inner tube 12 and moves vertically through the lower slant A1 of the lower spring receiver 32 and the upper slant A2 of the slider 102. The lower spring receiver 32 adjusts the initial length of the suspension spring 33 between the upper spring receiver 31 on the side of the piston rod 23 and the lower spring receiver 32, and adjusts the spring load of the suspension spring 33.

As shown in FIGS. 7A to 7C, in the spring, load adjusting apparatus 100, a vertical groove 32E extending 0over the entire length of the cylindrical portion 32A is provided on the outer periphery of the cylindrical portion 32A of the lower spring receiver 32 which slides on the outer periphery of the inner tube 12. In this way, the oil chamber 21 in the upper portion of the lower spring receiver 32 is brought into communication with the back surface chamber 21C of the lower spring receiver 32. As the lower spring receiver 32 moves vertically, oil in the oil chamber 21 can be supplied to and discharged from the back surface chamber 21C.

In the spring load adjusting apparatus 100, as shown in FIGS. 9A and 9B, the slider 102 may directly be provided with a screw portion 102A (nut portion), or the nut may be fitted and fixed to the slider 102 so that the nut 105 which is separated from the slider 102 is not required, and the number of parts can be reduced.

According to this embodiment, the following effects can be obtained.

(a) The horizontal movement of the slider 102 which moves straight in a direction by the rotation force of the adjusting bolt 101 is converted into the vertical movement of the lower spring receiver 32 through the abutment between the lower slant A1 of the lower spring receiver 32 and the upper slant A2 of the slider 102.

(b) Since the adjusting bolt 101 is provided on the bottom such as to face the outside at the position separated from the axle mounting hole 16 of the inner tube 12, the spring load of the suspension spring 33 can be adjusted even in the state in which the front fork 10 is not detached from the axle.

(c) A load of the suspension spring 33 is supported directly by the slider 102 and the adjusting bolt 101 without using the pump piston and the pressurizing chamber for the working oil. The sealing structure of working oil can be simple, the machining operation and the assembling operation of parts can be simplified and its operation reliability is also enhanced.

(d) The lower slant A1 of the lower spring receiver 32 and the upper slant A2 of the slider 102 have the same gradients. They abut against each other over their entire surfaces, and sufficient spring load adjusting width and durability can be secured.

(e) Since the lower end projection 32B (the lower vertical surface B and the lower slant A1) of the lower spring receiver 32 is sandwiched between the end surface of the washer 104 provided on one side of the adjusting bolt 101 and the upper slant A2 of the slider 102 provided on the other end of the adjusting bolt 101, it is possible to easily constitute 25 a mechanism which vertically moves the lower spring receiver 32 by the adjusting bolt 101 and the slider 102.

(f) The working oil chamber 21 above the lower spring receiver 32 is brought into the back surface chamber 21C of the lower spring receiver 32 in the inner tube 12. Therefore, only the spring load of the suspension spring 33 can be adjusted by the vertical motion of the lower spring receiver 32.

In the front fork 10, the O-ring is fitted to the outer peripheral groove of the lower spring receiver 32, the lower spring receiver 32 is liquid tightly fitted into the inner periphery of the inner tube 12 in the inner tube 12, and the oil chamber 21 above the lower spring receiver 32 may be sealed liquid tightly against the back surface chamber 21C of the lower spring receiver 32. According to this structure, the vertical motion of the lower spring receiver 32 in the inner tube 12 also vertically moves the oil level in the oil reservoir chamber 22 through the working oil chamber 21 of the inner tube 12. Therefore, the spring load of the suspension spring 33 is adjusted by the vertical motion of the lower spring receiver 32. If the oil level in the oil reservoir chamber 22 increases, the air chamber 22B can be expanded and shrunk and as a results the spring load of the air spring can also be adjusted.

As heretofore explained; embodiments of the present invention have been described in detail with reference to the drawings. However, the specific configurations of the present invention are not limited to the illustrated embodiments but those having a modification of the design within the range of the presently claimed invention are also included in the present invention.

Although the invention has been illustrated and described with respect to several exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiment set out above, but should be understood to include all possible embodiments which can be encompassed within a scope of equivalents thereof with respect to the features set out in the appended claims.

What is claimed is:

1. A hydraulic shock absorber in which an axle-side inner tube is slidably inserted into a vehicle body-side outer tube,
the inner tube is provided at its inner periphery with a partition wall member, a working oil chamber is defined below the partition wall member, and an oil reservoir chamber is defined above the partition wall member,
a piston support member mounted on the side of the outer tube is inserted into the working oil chamber such as to penetrate the partition wall member, the piston support member is provided at its tip end with a piston which slides in the working oil chamber,
a suspension spring is interposed between an upper spring receiver on the side of the piston support member and a lower spring receiver on the side of a bottom of the inner tube in the working oil chamber of the inner tube, wherein
an adjusting bolt facing outside is provided on a bottom of the inner tube at a location deviated from an axle mounting hole of the bottom of the inner tube,
a slider provided on the bottom of the inner tube is straightly moveable in a straight direction intersecting with a center axis of the inner tube by rotation force of the adjusting bolt,
a lower slant of the lower spring receiver is disposed on an upper slant of the slider, the lower spring receiver is vertically moveable by rotation of the adjusting bolt, thereby adjusting the spring load of a suspension spring.

2. The hydraulic shock absorber according to claim 1, wherein a first washer is abutted against a step surface of one end of the adjusting bolt, the slider is attached to the other end of the adjusting bolt, a nut portion added to the slider is threadedly engaged with a screw portion of the adjusting bolt,
the lower slant of the lower spring receiver is placed on the upper slant of the slider, and a lower vertical surface of the lower spring receiver is abutted against an end surface of the first washer.

3. The hydraulic shock absorber according to claim 1, wherein the working oil chamber above the lower spring receiver is brought into communication with a back surface chamber of the lower spring receiver in the inner tube.

4. The hydraulic shock absorber according to claim 2, wherein the working oil chamber above the lower spring receiver is brought into communication with a back surface chamber of the lower spring receiver in the inner tube.

5. The hydraulic shock absorber according to claim 1, wherein the working oil chamber above the lower spring receiver is sealed against a back surface chamber of the lower spring receiver in the inner tube.

6. The hydraulic shock absorber according to claim 2, wherein the working oil chamber above the lower spring receiver is sealed against a back surface chamber of the lower spring receiver in the inner tube.

7. A hydraulic shock absorber in which an axle-side inner tube is slidably inserted into a vehicle body-side outer tube,
an axle bracket is threadedly engaged with a lower end of the inner tube,
the inner tube is provided at its inner periphery with a partition wall member, a working oil chamber is defined below the partition wall member, and an oil reservoir chamber is defined above the partition wall member,
a piston support member mounted on the side of the outer tube is inserted into the working oil chamber such as to penetrate the partition wall member, the piston support member is provided at its tip end with a piston which slides in the working oil chamber, and
a suspension spring is interposed between an upper spring receiver on the side of the piston support member and a lower spring receiver on the side of the axle bracket in the working oil chamber of the inner tube, wherein
the lower spring receiver is inserted into the axle bracket so as to be prevented from being rotated with respect to the axle bracket,
the hydraulic shock absorber comprising:
a spring load adjusting apparatus that include an adjusting bolt facing outside provided on the axle bracket at a location deviated from an axle mounting hole of the axle bracket, allowing vertical movement of the lower spring receiver by rotation of the adjusting bolt, thereby adjusting the spring load of the suspension spring,
a second washer, which is assembled around the lower end projection of the lower spring receiver and is retained to enlarged portions provided at the tip end of the lower end projection so that the enlarged portions are prevented from falling, is attached to a step portion of the axle bracket, and
the tip end of the inner tube, which is threadedly engaged with the axle bracket, is supported by the second washer.

8. The hydraulic shock absorber according to claim 7, wherein a rotation preventing groove provided on the lower end projection of the spring receiver sandwiches an intermediate portion of the adjusting bolt of the spring load adjusting apparatus, so that the spring receiver is prevented from being rotated with respect to the axle bracket.

9. The hydraulic shock absorber according to claim 7, wherein when the inner tube and the axle bracket are assembled, the second washer is restrained by an O-ring attached to an annular groove of the axle bracket and is not separated.

10. The hydraulic shock absorber according to claim 8, wherein when the inner tube and the axle bracket are assembled, the second washer is restrained by an O-ring attached to an annular groove of the axle bracket and is not separated.

11. The hydraulic shock absorber according to cam 7, wherein spring load adjusting apparatus makes the first washer be abutted against a step surface of one end of the adjusting bolt, makes a slider be attached to the other end of the adjusting bolt, makes the slider be capable of straight movement in a direction intersecting with a center axis of the inner tube by rotation force of the adjusting bolt,
makes a lower slant of the lower spring receiver be placed on an upper slant of the slider, and makes a lower vertical surface of the lower spring receiver be abutted against an end surface of the first washer.

12. The hydraulic shock absorber according to claim 8, wherein spring load adjusting apparatus makes the washer be abutted against a step surface of one end of the adjusting bolt, makes a slider be attached to the other end of the adjusting bolt, makes the slider be capable of sight movement in a direction intersecting with a center axis of the inner tube by rotation force of the adjusting bolt,
makes a lower slant of the lower spring receiver be placed on an upper slant of the slider, and makes a lower vertical surface of the lower spring receiver be abutted against an end surface of the first washer.

13. The hydraulic shock absorber according to claim 9, wherein spring load adjusting apparatus makes the washer be abutted against a step surface of one end of the adjusting bolt, makes a slider be attached to the other end of the adjusting bolt, makes the slider to be capable of straight movement in a direction intersecting with a center axis of the inner tube by rotation force of the adjusting bolt,
makes a lower slant of the lower spring receiver be placed on an upper slant of the slider, and makes a lower vertical surface of the lower spring receiver be abutted against an end surface of the first washer.

14. The hydraulic shock absorber according to claim 10, wherein spring load adjusting apparatus makes the washer be abutted against a step surface of one end of the adjusting bolt, makes a slider be attached to the other end of the adjusting bolt, makes the slider be capable of straight movement in a direction intersecting with a center axis of the inner tube by rotation force of the adjusting bolt,
makes a lower slant of the lower spring receiver be placed on an upper slant of the slider and makes a lower vertical surface of the lower spring receiver be abutted against an end surface of the first washer.

15. The hydraulic shock absorber according to 7, wherein in the lower spring receiver, the lower end projection projects from a bottom of a bottomed cylindrical portion, a cup-like spring collar is fitted in a liquid-tight arrangement to an opening of an upper end of the cylindrical portion, and a flange of the spring collar is placed on the upper end surface of the cylindrical portion.

16. The hydraulic shock absorber according to claim 8, wherein in the lower spring receiver, the lower end projection projects from a bottom of a bottomed cylindrical portion, a cup-like spring collar is fitted in a liquid-tight arrangement to an opening of an upper end of the cylindrical portion, and a flange of the spring collar is placed on the upper end surface of the cylindrical portion.

17. The hydraulic shock absorber according to claim 9, wherein in the lower spring receiver, the lower end projection projects from a bottom of a bottomed,cylindrical portion, a cup-like spring collar is fitted in a liquid-tight arrangement to an opening of an upper end of the cylindrical portion, and a flange of the spring collar is disposed on the upper end surface of the cylindrical portion.

18. The hydraulic shock absorber according to claim 15, wherein a vertical groove extending over the enter length of the cylindrical portion is disposed on the outer periphery of the cylindrical portion of the lower spring receiver.

19. The hydraulic shock absorber according to claim 16, wherein a vertical groove extending over the entire length of the cylindrical portion is disposed on the outer periphery of the cylindrical portion of the lower spring receiver.

20. The hydraulic shock absorber according to claim 17, wherein a vertical groove extending over the entire length of the cylindrical portion is disposed on the outer periphery of the cylindrical portion of the lower spring receiver.
